(19) United States
(12) Patent Application Publication
(10) Pub. No.: US 2024/0157675 A1
(43) Pub. Date: May 16, 2024

(54) Gypsum Panel Containing Additives for Improved Fire Resistance

(71) Applicant: Gold Bond Building Products, LLC, Charlotte, NC (US)

(72) Inventors: Eli Stav, Charlotte, NC (US); Bradley J. Busche, Shelby, NC (US); R. G. Iyer, Charlotte, NC (US); Jie Ling, Irmo, SC (US); Veda Evans, Charlotte, NC (US); Joseph J. Bailey, Charlotte, NC (US)

(21) Appl. No.: 18/507,220

(22) Filed: Nov. 13, 2023

Related U.S. Application Data
(60) Provisional application No. 63/425,059, filed on Nov. 14, 2022.

(51) Int. Cl. B32B 13/02; B32B 13/04; B32B 37/15; C04B 14/06; C04B 14/18; C04B 14/20; C04B 14/22; C04B 18/14; C04B 20/00; C04B 22/06; C04B 22/12; C04B 24/42; C04B 28/14; E04C 2/04

(52) U.S. Cl. CPC B32B 13/02; B32B 13/04; B32B 37/15; C04B 14/062; C04B 14/185; C04B 14/202; C04B 14/22; C04B 18/146; C04B 20/004; C04B 22/06; C04B 22/124; C04B 24/42; C04B 28/14; E04C 2/043; B32B 2250/40; B32B 2264/10; B32B 2264/101; B32B 2264/1021; B32B 2264/1027; B32B 2264/203; B32B 2307/304; B32B 2307/3065; B32B 2307/308; B32B 2307/54; B32B 2318/00; B32B 2607/00; C04B 2111/0062

(57) ABSTRACT

The present invention is directed to a gypsum panel and a method of making such gypsum panel. For instance, the gypsum panel comprises a gypsum core and a first facing material and a second facing material sandwiching the gypsum core. The gypsum core includes gypsum, a thermal insulation additive, and a shrinkage reduction additive. The gypsum core includes 3 wt. % or less of vermiculite based on the weight of the gypsum in the gypsum core. The gypsum panel passes ASTM E119-20.

### CROSS-REFERENCE TO RELATED APPLICATION

The present application claims filing benefit of U.S. Provisional Patent Application Ser. No. 63/425,059 having a filing date of Nov. 14, 2022, and which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum, water, and other conventional additives. In certain instances, these additives may include materials that are utilized to improve the fire resistance of the gypsum panel. When utilizing certain additives, the gypsum panels may have a loss in thickness and shrink thereby allowing for undesired fire and heat propagation resulting in a reduction in the amount of time permitted for evacuation.

As a result, there is a need to provide an improved gypsum panel that provides an improvement in the fire resistance.

### SUMMARY OF THE INVENTION

In accordance with one embodiment of the present invention, a gypsum panel is disclosed. The gypsum panel comprises a gypsum core and a first facing material and a second facing material sandwiching the gypsum core, wherein the gypsum core includes gypsum, a thermal insulation additive, and a shrinkage reduction additive. The gypsum core includes 3 wt. % or less of vermiculite based on the weight of the gypsum in the gypsum core. The gypsum panel passes ASTM E119-20.

In accordance with another embodiment of the present invention, a method of making a gypsum panel is disclosed. The method comprises: providing a first facing material, providing a gypsum slurry comprising gypsum, water, a thermal insulation additive, and a shrinkage reduction additive onto the first facing material, and providing a second facing material on the gypsum slurry.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel includes a gypsum core including a mixture of a thermal insulation additive and a shrinkage reduction additive. The present inventors have discovered that the gypsum panel disclosed herein can have various benefits due to the use of these additives. For instance, the present inventors have discovered that the fire resistance properties and characteristics of the panel may be improved.

For instance, the gypsum panel as disclosed herein can pass certain tests. In some embodiments, the gypsum board can pass certain tests that are typically utilized for assessing fire resistance. In particular, in some embodiments, the gypsum panel as disclosed herein can pass ASTM E119-20.

Even further, the gypsum panel may be able to pass such test while eliminating or utilizing a reduced amount of vermiculite. For instance, vermiculite has been generally utilized in the past in order to pass such test. However, utilizing the additives as disclosed herein combination, the gypsum panel may pass such test without requiring vermiculite to the extent historically required. In this regard, the vermiculite may generally be in the gypsum, if present, in an amount of 2 wt. % or less based on the weight of gypsum in the gypsum core. In this regard, the vermiculite may be present in an amount of 3 wt. % or less, such as 2.5 wt. % or less, such as 2.3 wt. % or less, such as 2 wt. % or less, such as 1.8 wt. % or less, such as 1.6 wt. % or less, such as 1.4 wt. % or less, such as 1.2 wt. % or less, such as 1 wt. % or less, such as 0.8 wt. % or less, such as 0.6 wt. % or less, such as 0.4 wt. % or less, such as 0.2 wt. % or less, such as 0.1 wt. % or less, such as 0.05 wt. % or less, such as 0.01 wt. % or less, such as 0.005 wt. % or less, such as 0 wt. %. In one particular embodiment, the vermiculite may be present in an amount of 0 wt. % based on the weight of gypsum in the gypsum core.

In addition, the gypsum panel as disclosed herein may have a relatively reduced shrinkage. The shrinkage can be determined via thermomechanical analysis (TMA) using the ASTM E119 heating ramp rate as defined below. For instance, the test is conducted to determine the dimensional changes when exposing the gypsum panel to elevated temperatures. In particular, the shrinkage is determined based on the z (or thickness) direction of the gypsum panel. The change in thickness of the gypsum panel can also be determined when exposing the gypsum panel to elevated temperatures. In general, maintaining or increasing the board thickness relative to conventional panel shrinkage upon exposure to fire/elevated temperatures results in improved thermal insulation. However, using the muffle furnace test as defined herein, the shrinkage may also be provided as a function of area.

In this regard, in one embodiment, the shrinkage of the gypsum panel as determined via thermomechanical analysis for the thickness direction is about 15% or less, such as about 12% or less, such as about 10% or less, such as about 9% or less, such as about 8% or less, such as about 7% or less, such as about 6% or less, such as about 5% or less, such as about 4% or less, such as about 3% or less, such as about 2% or less, such as about 1% or less, such as about 0.5% or less. In general, the shrinkage may be greater than 0%, such as about 0.1% or more, such as about 0.2% or more, such as about 0.5% or more, such as about 1% or more, such as about 2% or more, such as about 3% or more, such as about 5% or more.

In one embodiment, the shrinkage area of the gypsum panel as determined in the muffle furnace test is about is about 15% or less, such as about 12% or less, such as about 10% or less, such as about 9% or less, such as about 8% or less, such as about 7% or less, such as about 6% or less, such as about 5% or less, such as about 4% or less, such as about 3% or less, such as about 2% or less, such as about 1% or less, such as about 0.5% or less. In general, the shrinkage may be greater than 0%, such as about 0.1% or more, such as about 0.2% or more, such as about 0.5% or more, such as about 1% or more, such as about 2% or more, such as about 3% or more, such as about 5% or more.

As indicated herein, the present invention discloses a gypsum panel. The gypsum panel includes a gypsum core having a gypsum layer surface. In particular, the gypsum layer surface includes a first gypsum layer surface and a second gypsum layer surface opposing the first gypsum layer surface. A facing material is provided on the gypsum layer surface. For instance, a first facing material is provided on the first gypsum layer surface and a second facing material is provided on the second gypsum layer surface. In this regard, the first facing material and the second facing material sandwich the gypsum core.

In general, the gypsum core, may comprise calcium sulfate dihydrate. In addition, the gypsum core also comprises a thermal insulation additive and a shrinkage reduction additive. The gypsum core may also include other additives as disclosed herein. The gypsum core is generally made from a gypsum slurry, as also disclosed herein, including water and the thermal insulation additive and the shrinkage reduction additive. The present inventors have discovered that utilizing both the thermal insulation additive and the shrinkage reduction additive in combination as disclosed herein may be provide synergistic benefits in order to provide the necessary fire resistance properties and characteristics.

For instance, generally speaking, a shrinkage resistant additive can be utilized to interfere with the sintering of gypsum crystals. Without intending to be limited by theory, such sintering would result in shrinkage of the panel thereby affecting the overall dimensions of the panel. For instance, such additives may be present at a gypsum/gypsum interface to interrupt fusion of the gypsum crystals into one mass or agglomeration. Furthermore, the thermal insulation additive may be utilized to reduce the flow of heat from a front face of a gypsum panel to a back face of a gypsum panel. In this regard, the temperature along the back of a panel, when installed, may be less than a similar gypsum panel without such an additive.

In general, the thermal insulation additive may have a specific mechanism or means of absorbing heat. For instance, it may be referred to as an endothermic additive, a thermally resistant additive, a flame-retardant additive, an intumescent additive, or a charring additive. In this regard, each mechanism may be distinguishable from another. For instance, without intending to be limited by theory, the mechanism may be as follows: (a) endothermic material—absorbs heat and delays thermal transmission before undergoing a chemical transformation (e.g., calcium sulfate dehydrate losing water upon exposure to heat) often requiring more energy to undergo chemical change than its matrix; (b) thermally resistant material—undergoes chemical (or physical) change at temperatures higher than its corresponding matrix (e.g., the gypsum core) and potentially provides reinforcement/shrinkage resistance upon exposure to heat and fire as a result and may also be a material that shows low heat transfer; (c) flame retardant material—resists the chemical reaction associated with burning to improve flame retardancy (e.g., to improve the gypsum flame retardant and smoke developed classes of gypsum materials) wherein the suppression can occur via various mechanisms from gas/vapor release to char formation; (d) intumescent additive—expands along one or more axes to increase in volume upon exposure to heat wherein the expansion causes the matrix itself to expand which in turn increases the thermal resistance (heat/thermal delay) of the matrix itself; and (e) charring additives—undergo a chemical degradation reaction to create an insulation layer to protect against heat and fire. It should be understood that the aforementioned provides general descriptions and thus should not be limiting.

However, regardless of the mechanism, such additive may be able to reduce the flow of heat from a front face of a gypsum panel to a back face of a gypsum panel. For instance, it may be able to slow heat conduction and/or convection through the gypsum panel. Furthermore, it should be understood that the aforementioned additives may be utilized individually or in any combination.

In this regard, the thermal insulation additive may be an endothermic material. For instance, endothermic materials may generally absorb energy or heat from the surrounding. In this regard in certain embodiments, such materials may be capable of absorbing energy without undergoing a phase change. These may include a hydrate, a hydroxide, a borate, a phosphate, a carbonate, a nitrate, a clay, as well as a mixture thereof.

For instance, the thermal insulation additive may include a hydrate such as mineral hydrates. The hydrates may include chlorite, muscovite, brucite, goethite, hydromagnesite, talc, saponite, amphibole, lawsonite, zoisite, chloritoid, borax, sodium tetra borate decahydrate, sodium carbonate decahydrate, sodium sulfate decahydrate, zeolites, sodium phosphate tribasic dodecahydrate, ettringite, magnesium phosphate pentahydrate, magnesium sulfate heptahydrate, magnesium carbonate basic pentahydrate, aluminum oxide hydrate, aluminum trihydrate, boehmite, magnesium hydrate, calcium hydrate, or a mixture thereof. In certain embodiments, the hydrate may be a vapor emissive material.

The thermal insulation additive may include a hydroxide, such as metal hydroxides. The hydroxides may include magnesium hydroxide, calcium hydroxide, aluminum hydroxide, or a mixture thereof.

The thermal insulation additive a borate. For instance, the borate may include sodium borate, zinc borate, boric acid, tincalconite, clemanite, ulexite, or a mixture thereof.

The thermal insulation additive may include a phosphate. For instance, the phosphonate may include magnesium phosphate, hydroxyapatite, or a mixture thereof. The thermal insulation additive may include a carbonate. For instance, the carbonate may include magnesium carbonate, calcium carbonate, or a mixture thereof. The thermal insulation additive may include a nitrate. For instance, the nitrate may include sodium nitrate. The thermal insulation additive may include a clay. For instance, the clay may be smectite.

In one embodiment, the thermal insulation additive may be a thermally resistant additive. The thermally resistant additive may include volcanic ash, an aerogel, soda-lime glass, a borosilicate glass, or a mixture thereof. For instance, the volcanic ash may be tuff. Furthermore, these materials may also include aerogels. The soda-lime glass may include glass beads, glass bubbles, glass spheres, or a mixture thereof. The glass may also be various types of glass such as glass derived from bottles or recycled and is thus not necessarily limited.

In another embodiment, the thermal insulation additive may be a charring additive. For instance, the charring additive may be a polyphosphate. For instance, the polyphosphate may be ammonium polyphosphate, melamine polyphosphate, or a mixture thereof.

In a further embodiment, the thermal insulation additive may be a flame-retardant type additive. Such additives may include red phosphorus, a phosphate, a phosphoric acid, a phosphonic acid, or a mixture thereof. For instance, the phosphate may include a melamine phosphate, ammonium polyphosphate, tris(1,3-dichloro-2propane) phosphate, 2-propanol,1,3-dichloro-phosphate, phosphoric acid tris(2-chloro-1-methylethyl) ester, resorcinol bis(diphenylphosphate), tris(isopropylated-phenyl) phosphate, brominated flame retardants, polymeric flame retardants, or a mixture thereof. The phosphonic acid may include phosphonic acid, methyl-bis(5-ethyl-2-methyl-1,3,2-diozaphosphosphorian-5-yl) methyl)ester. Flame retardants may also include egg shells, oyster shells, or a mixture thereof.

In another embodiment, the thermal insulation additive may be an intumescent material. For instance, the intumescent material may include graphite, vermiculite, or a mixture thereof. The graphite may be unexpanded or expanded. The vermiculite may be unexpanded or expanded. In addition, the vermiculite may be any grade or combination of grades as known in the art.

In another further embodiment, the thermal insulation additive may be a synergist type material, in particular for improving fire resistance. Such materials may include antimony. For instance, the additive may include antimony trioxide, antimony pentoxide, or a mixture thereof.

In general, the shrinkage reduction additive may be an additive that reduces the gypsum panel's overall shrinkage relative to a control panel that may not include such an additive. In this regard, the shrinkage reduction additive may include a silicone, a silicate, a silica, a ceramic oxide, a metal salt, or a mixture thereof. For instance, in one embodiment, such additive may be a silicate. In another embodiment, such additive may be a silica. In a further embodiment, such additive may be a ceramic oxide. In another embodiment, such additive may be a silicone. In a further embodiment, such additive may be a metal salt.

In one embodiment, the shrinkage reduction additive includes a silicone. The silicone may be a silicone oil, a polysiloxane, etc. In another embodiment, the shrinkage reduction additive includes a silica. For instance, the silica may include a silica gel, silica fume, a fumed silica, a fused silica, a colloidal silica, a precipitated silica, a crystalline or amorphous silica, or a mixture thereof. The silica may be a colloidal silica. In a further embodiment, the shrinkage reduction additive may be a ceramic oxide.

In another embodiment, the shrinkage reduction additive may be a silicate. For instance, it may be a silicate mineral. For instance, the silicate may be kaolin clay, an alumino-silicate, etc. or a mixture thereof. The shrinkage reduction additive may include kaolin clay, fillite, expanded fly ash, perlite (perlite ore), pumice (e.g., ground pumice) volcanic ash (tuff), diatomite, phlogopite mica, wollastonite, pyrophyllite, sodium silicate, calcium silicate, or a mixture thereof.

In a further embodiment, the shrinkage reduction additive may be a metal salt. For instance, the metal salt may include a halide, such as fluoride or chloride. In this regard, the metal salt may include a strontium salt, an iron salt, a barium salt, or a mixture thereof. For instance, the metal salt may include a strontium chloride, an iron chloride, barium chloride, or a mixture thereof. In one particular embodiment, the metal salt may include an iron chloride. In another embodiment, the metal salt may include a barium chloride.

The thermal insulation additive and/or the shrinkage reduction additive may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more. The thermal insulation additive and/or the shrinkage reduction additive may be present in an amount of 150 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

The thermal insulation additive and/or the shrinkage reduction additive may be present in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the gypsum panel. The thermal insulation additive and/or the shrinkage reduction additive may be present in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the gypsum panel. Alternatively, the weight percentage may be based on the weight of the gypsum core. In a further embodiment, such weight percentage may be based on the weight of the gypsum within the gypsum core. In an even further embodiment, such weight percentage may be based on the weight of a respective gypsum core layer. Also, the aforementioned weight percentages may be based on the solids content of the gypsum slurry. In addition, such weight percentage may be based on the weight of the gypsum slurry.

In general, the composition of the gypsum core is not necessarily limited and may include any additives as known in the art. For instance, the additives may include dispersants, foam or foaming agents including aqueous foam (e.g. sulfates, alkyl ether sulfates, etc.), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass spheres, glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches, sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present invention.

Each additive may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less. The aforementioned weight percentages may also apply based on the weight of the gypsum in the gypsum panel. In one embodiment, the aforementioned weight percentages may also apply based on the weight of the gypsum panel. Alternatively, the weight percentages may be based on the weight of the gypsum core. In a further embodiment, such weight percentages may be based on the solids content of the gypsum slurry. In addition, such weight percentage may be based on the weight of the gypsum slurry.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes a thermal insulation additive and a shrinkage reduction additive. In another embodiment, at least one gypsum slurry includes a thermal insulation additive, a shrinkage reduction additive, and an endothermic additive as defined herein. In this regard, the method may include a step of also combining the thermal insulation additive and the shrinkage reduction additive, and if present an endothermic additive, with the stucco, water, and any optional additives as indicated herein.

In general, stucco may be referred to as calcined gypsum or calcium sulfate hemihydrate. The calcined gypsum may be from a natural source, a synthetic source, or a combination, and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In addition to the stucco, the gypsum slurry may also contain other hydraulic materials. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

The thermal insulation additive and/or the shrinkage reduction additive may be present in the gypsum slurry in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the stucco. The thermal insulation additive and/or the shrinkage reduction additive may be present in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco. In another embodiment, such weight percentage may be based on the weight of the gypsum slurry. In a further embodiment, such weight percentage may be based on the solids content of the gypsum slurry.

As indicated above, the gypsum slurry may also include water. Water may be employed for fluidity and also for rehydration to the gypsum to allow for setting. The amount of water utilized is not necessarily limited by the present invention.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates, alkyl ether sulfates, etc.), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present invention.

Each additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the stucco. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco. In another embodiment, such weight percentage may be based on the weight of the gypsum slurry. In a further embodiment, such weight percentage may be based on the solids content of the gypsum slurry.

As indicated above, the additives may include at least one foaming agent. The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more based on the combined weight of the alkyl sulfate and the alkyl ether sulfate.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfate.

The manner in which the components for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the additives may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for dewatering of the gypsum slurry, in particular dewatering any free water instead of combined water of the gypsum slurry. Such dewatering may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal of any free water. The temperature and time required for drying in such heating device are not necessarily limited by the present invention.

In one embodiment, the gypsum core may include a first gypsum core layer and a second gypsum core layer. The first gypsum core layer may be between the first facing material (i.e., front of the panel) and the second gypsum core layer. In addition, the first gypsum core layer may have a density greater than the second gypsum core layer. Accordingly, the first gypsum core layer may be formed using a gypsum slurry without the use of a foaming agent or with a reduced amount of foaming agent, which may be utilized in forming the second gypsum core layer. In this regard, in one embodiment, the first gypsum core layer may have the same composition as the second gypsum core layer except that the second gypsum core layer may be formed using a foaming agent or a greater amount of foaming agent.

In one embodiment, the gypsum core may also include a third gypsum core layer. The third gypsum core layer may be provided between the second gypsum core layer and a second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of a foaming agent or with a reduced amount of foaming agent, which may be utilized in forming the second gypsum core layer. In this regard, in one embodiment, the third gypsum core layer may have the same composition as the second gypsum core layer except that the second gypsum core layer may be formed using a foaming agent or a greater amount of foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include a foaming agent or more foaming agent than the first gypsum slurry. In this regard, in one embodiment, the first gypsum slurry may not include a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent or more foaming agent than the third gypsum slurry. In this regard, in one embodiment, the third gypsum slurry may not include a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

In addition, the first gypsum core layer, the second gypsum core layer, and/or the third gypsum core layer may also have the additives as mentioned above. For instance, as indicated herein, the gypsum core includes a thermal insulation additive and a shrinkage reduction additive. In this regard, in one embodiment, the first gypsum core layer may include the thermal insulation additive and the shrinkage reduction additive as mentioned above. For instance, the additives may be present in the amounts as also mentioned herein. In another embodiment, the second gypsum core layer may include the thermal insulation additive and the shrinkage reduction additive as mentioned above. For instance, the additives may be present in the amounts as also mentioned herein. In a further embodiment, the third gypsum core layer may include the thermal insulation additive and the shrinkage reduction additive as mentioned above. For instance, the additives may be present in the amounts as also mentioned herein. In an even further embodiment, the first gypsum core layer and the second gypsum core layer may include the thermal insulation additive and the shrinkage reduction additive as mentioned above. In another further embodiment, the first gypsum core layer, the second gypsum core layer, and the third gypsum core layer may include the thermal insulation additive and the shrinkage reduction additive as mentioned above. Regardless of the above, the thermal insulation additive and the shrinkage reduction additive may be present in any combination of gypsum core layers. In addition, the additives may be present in the amounts as also mentioned herein. However, in one embodiment, it should be understood that one or two of the aforementioned core layers may not include the thermal insulation additive and the shrinkage reduction additive. For instance, the thermal insulation additive and/or the shrinkage reduction additive may be present in an amount of less than 0.1 wt. %, such as less than 0.05 wt. %, such as less than 0.01 wt. %, such as less than 0.005 wt. %.

The gypsum panel disclosed herein may have many applications. For instance, the gypsum panel may be used as a standalone panel in construction for the preparation of walls, ceilings, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 5 pcf or more, such as about 6 pcf or more, such as about 7 pcf or more, such as about 8 pcf or more, such as about 9 pcf or more, such as about 10 pcf or more, such as about 11 pcf or more, such as about 12 pcf or more, such as about 13 pcf or more, such as about 14 pcf or more, such as about 15 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less, such as about 15 pcf or less, such as about 14 pcf or less, such as about 13 pcf or less, such as about 12 pcf or less, such as about 11 pcf or less, such as about 10 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396 and ASTM C473. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396 and ASTM C473. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, it may also be desired to have an effective bond between the facing material and the gypsum core. Typically, a humidified bond test is performed for 2 hours in a humidity chamber at 90° F. and 90% humidity. In this test, after exposure, the facing material is removed and the bond is assessed using one of the two following characterizations: percentage of facing material remaining on the core and/or percentage of gypsum present on the facing material once removed. The percent coverage (or surface area) can be determined using various optical analytical techniques. In this regard, the percentage coverage may be less than 100%, such as 99% or less, such as 98% or less, such as 95% or less, such as 93% or less, such as 90% or less, such as 80% or less, such as 70% or less, such as 60% or less, such as 50% or less, such as 40% or less, such as 30% or less, such as 25% or less, such as 20% or less, such as 15% or less, such as 10% or less, such as 9% or less, such as 8% or less, such as 5% or less, such as 3% or less, such as 2% or less. The percent coverage may be more than 0%, such as 2% or more, such 5% or more, such as 10% or more, such as 15% or more, such as 20% or more, such as 30% or more, such as 40% or more, such as 50% or more, such as 60% or more, such as 70% or more, such as 75% or more, such as 80% or more, such as 85% or more, such as 90% or more, such as 92% or more, such as 95% or more, such as 97% or more, such as 98% or more. Such percentage may be based on removal of the facing material on the face of the gypsum board. Alternatively, such percentage may be based on removal of the facing material on the back of the gypsum board. Further, such percentages may be based on removal of the facing material on both the face and back of the gypsum board. In addition, such values may be for an average of at least 3 gypsum boards, such as at least 5 gypsum boards.

In general, upon removal of the facing material, depending on the “failure” of the facing material, some of the facing material may remain on the gypsum core and/or some of the gypsum may adhere to the facing material. With facing material remaining on the gypsum core and minimizing the amount of gypsum adhered to the facing material, this can indicate a relatively strong gypsum-facing material bond. For instance, this may indicate a general “failure” or weakening within the facing material rather than the gypsum core-facing material bond. In this regard, regarding the above-referenced humidified bond test, in one embodiment, such percentages may be based on the percent coverage of gypsum on the facing material. Generally, it may be desired to have a low percent coverage based on this approach. In another embodiment, such humidified bond test may be based on the percent coverage of the facing material remaining on the gypsum core upon removal. Generally, it may be desired to have a relatively high percent coverage based on this approach.

### EXAMPLES

### Test Methods

Shrinkage Test: The change in thickness was measured using a TA Instruments TMA 2940 and the temperature ramp rate as identified in E119-20. The sample was 5 mm by 5 mm in size. It was equilibrated at room temperature for 2 minutes and then heated. In addition, a preload and applied force of 0.3 N was used. The test was conducted in a nitrogen atmosphere with a flow rate of 50 mL/min. In particular, the sample was heated based on the below ramp rate:

| Temperature (° C.) | Time | Ramp Rate (° C./min) |
|---|---|---|
| 538 | at 5 min | 107 |
| 704 | at 10 min | 33 |
| 843 | at 30 min | 7 |
| 927 | at 1 hour | 3 |

The coefficient of dimension change was calculated using the “Alpha X1 to X2” operation in the TA universal analysis software.

Muffle Furnace Test: The muffle furnace test focuses on the x-y direction/area of the board. The shrinkage performance of gypsum with various additives are examined using a cast gypsum bar with a water to stucco ratio of 0.85 having dimensions of 1″×1″×11.25″ or a gypsum panel cut to 2″×0.625″×11.25 (based on the panel's thickness). This bar or panel sample is dried at 45° C. until constant mass, then conditioned at 70° F. and 50% RH for 12 hours. After conditioning, these samples are placed into a muffle furnace and ramped using the following modified E119 heat ramp rate: at 5 mins=165° C.; at 10 mins=330° C.; at 30 mins=843° C.; at 60 mins=927° C. All samples were dimensionally measured before and after heating where the initial sample area was compared to the post heating area. The samples were placed relatively flat within the furnace.

### Example 1

Gypsum panels were made using various thermal insulation additives and shrinkage resistance additives. Samples 1-3 included 8-10 lbs/msf silicone, samples 4-5 did not include any silicone, and samples 6-24 included 8 lbs/msf silicone. The additive percentages below are based on the initial stucco weight. For each of the samples, the change in thickness was determined at various temperatures to identify trends in the magnitude of shrinkage. In addition, the temperature at the back of panel was determined using the muffle furnace test wherein the panel was cut to fit over the opening of the front of the muffle furnace The sample was insulated with refractory wool between the sample edges and the furnace to fill in any gaps and seal the panel sample to the furnace. The furnace was ramped using the E119 ramp rate inside the oven and the thermocouple positioned at the center of the back of the panel measured the temperature of the unexposed side through the heating of the furnace.

| | | Board | | | | | | | |
|---|---|---|---|---|---|---|---|---|---|
| | | Wt. | | | | | | | |
| | | (lbs/ | Change in thickness (%) | | | | | | |
| No. | Sample Description | msf) | 300° C. | 350° C. | 400° C. | 450° C. | 600° C. | 850° C. | 950° C. |
| 1 | Control, 5/8″, no | 2282 | −0.24 | −0.34 | −0.40 | −2.1 | −3.1 | −7.4 | −31.1 |
| | vermiculite, | | | | | | | | |
| 2 | Control, 5/8″, 100 lb/msf | 2053 | −0.34 | −0.45 | −0.07 | +10.6 | +10.3 | −2.3 | −13.6 |
| | Vermiculite 5, | | | | | | | | |
| 3 | Control, 5/8″, 60 lb/msf | 1754 | −0.41 | −0.53 | −0.60 | −1.5 | −1.6 | −3.1 | −9.0 |
| | Vermiculite 5 | | | | | | | | |
| 4 | Control, no Vermiculite, | — | −0.26 | −0.38 | −0.53 | −2.05 | −3.04 | −11.16 | −24.77 |
| | no silicone | | | | | | | | |
| 5 | Control, no Vermiculite, | 1717 | 0.34 | −0.47 | −0.63 | −2.4 | −3.3 | −10.2 | −28.2 |
| | no silicone | | | | | | | | |
| 6 | No Vermiculite, | 1719 | −0.22 | −0.32 | −0.43 | −1.63 | −2.7 | −4.62 | −14.67 |
| 7 | No vermiculite, CTRL | 1731 | −0.14 | −0.26 | −0.32 | −1.1 | −1.2 | −2.2 | −10.0 |
| 8 | 1% Expanded perlite | 1771 | −0.47 | −0.48 | −1.7 | −2.6 | −3.1 | −3.7 | −22.5 |
| | (HP-100) | | | | | | | | |
| 9 | 2% Expanded perlite | 1852 | −0.24 | −0.31 | −0.42 | −2.1 | −2.5 | −3.2 | −15.0 |
| 10 | 1% Expanded perlite + 1% | 1817 | −0.48 | −0.51 | −1.8 | −2.6 | −3.0 | −3.5 | −11.0 |
| | condensed Silica Fume | | | | | | | | |
| 11 | 1% Expanded perlite + 2% | 1826 | −0.33 | −0.33 | −1.2 | −2.3 | −2.8 | −3.3 | −8.4 |
| | cond. Silica Fume | | | | | | | | |
| 12 | 2% Expanded perlite + 1% | 1880 | −0.35 | −0.37 | −1.5 | −2.2 | −2.7 | −3.2 | −11.0 |
| | cond. Silica Fume | | | | | | | | |
| 13 | 2% Expanded Perlite | 1686 | −0.46 | −0.48 | −1.4 | −2.5 | −3.2 | −3.8 | −20.1 |
| | (Aerosoil) | | | | | | | | |
| 14 | 1% Expanded Perlite | 1749 | −0.60 | −0.61 | −1.5 | −3.0 | −3.6 | −4.3 | −30.0 |
| 15 | 1% Expanded Perlite + 1% | 1752 | −0.29 | −0.35 | −0.62 | −2.37 | −2.9 | −3.4 | −8.7 |
| | Condensed Silica Fume | | | | | | | | |
| 16 | 2% Expanded Perlite + 1% | 1764 | −0.38 | −0.42 | −1.0 | −2.3 | −2.8 | −3.4 | −9.2 |
| | Condensed Silica Fume | | | | | | | | |
| 17 | 1% Colloidal silica | 1869 | −0.48 | −0.48 | −1.5 | −2.5 | −2.9 | −3.8 | −12.5 |
| | (Ludox SK) | | | | | | | | |
| 18 | 1% Aerosoil + 1% | 1636 | −0.27 | −0.38 | −0.46 | −2.1 | −2.7 | −3.4 | −8.4 |
| | Colloidal silica | | | | | | | | |
| 19 | 1% BaCl2 | 1873 | −0.27 | −0.39 | −0.44 | 1.87 | 2.91 | −5.07 | −24.38 |
| 20 | 1% Glass Bubbles (3M | 1827 | −0.19 | −0.27 | −0.45 | −1.7 | −2.59 | −6.81 | −25.04 |
| | K15) | | | | | | | | |
| 21 | 3% Glass Bubbles | 1729 | −0.13 | −0.24 | −0.3 | −1.49 | 2.29 | −26.28 | −26.28 |
| 22 | 1% Recycled Glass (Soda | 1821 | −0.2 | −0.31 | −0.4 | −1.85 | −2.93 | −5.84 | −31.64 |
| | Lime Silicate glass) | | | | | | | | |
| 23 | 1% BaCl2 + 1% | 1740 | −0.26 | −0.36 | −0.39 | −1.29 | −2.67 | −5.75 | −28.11 |
| | Recycled Glass | | | | | | | | |
| 24 | 1% BaCl2 + 3% | 1794 | −0.16 | −0.27 | −0.28 | −1.51 | −2.55 | −8.27 | −26.2 |
| | Recycled Glass | | | | | | | | |

| | | | | | Muffle |
|---|---|---|---|---|---|
| | | | | | Furnace |
| | | | | Shrink- | Temp. at |
| | | | | age, | 60 mins, |
| | | | | Post | Post |
| | | | TMA | E119 | E119 |
| | | | Thickness | heating | (samples |
| | | | @ | (flat | placed in |
| | | Board | 927° C., | samples | opening |
| | | Wt | 60 mins | within | of |
| | | (lbs/ | (thickness | furnace) | furnace) |
| No. | Sample Description | msf) | %) | (Area %) | (F.) |
| 1 | Control, 5/8″, no | 2282 | −16.5 | −15.5 | 491 |
| | vermiculite, | | | | |
| 2 | Control, 5/8″, 100 lb/msf | 2053 | −9.9 | −9.7 | 422 |
| | Vermiculite 5, | | | | |
| 3 | Control, 5/8″, 60 lb/msf | 1754 | −5.8 | −6.4 | 453 |
| | Vermiculite 5 | | | | |
| 4 | Control, no Vermiculite, | — | −24.77 | — | 462 |
| | no silicone | | | | |
| 5 | Control, no Vermiculite, | 1717 | −26.5 | — | 450 |
| | no silicone | | | | |
| 6 | No Vermiculite, | 1719 | −8.37 | — | 451 |
| 7 | No vermiculite, CTRL | 1731 | −5.6 | −16.4 | 458 |
| 8 | 1% Expanded perlite | 1771 | −9.3 | −14.6 | 466 |
| | (HP-100) | | | | |
| 9 | 2% Expanded perlite | 1852 | −8.5 | −14.2 | 490 |
| 10 | 1% Expanded perlite + 1% | 1817 | −6.5 | −10.7 | 486 |
| | condensed Silica Fume | | | | |
| 11 | 1% Expanded perlite + 2% | 1826 | −5.8 | −9.6 | 489 |
| | cond. Silica Fume | | | | |
| 12 | 2% Expanded perlite + 1% | 1880 | −6.4 | −11.2 | 483 |
| | cond. Silica Fume | | | | |
| 13 | 2% Expanded Perlite | 1686 | −8.3 | −12.8 | 471 |
| | (Aerosoil) | | | | |
| 14 | 1% Expanded Perlite | 1749 | −12.0 | −14.7 | 581 |
| 15 | 1% Expanded Perlite + 1% | 1752 | −5.8 | −9.4 | 461 |
| | Condensed Silica Fume | | | | |
| 16 | 2% Expanded Perlite + 1% | 1764 | −6.2 | −9.6 | 477 |
| | Condensed Silica Fume | | | | |
| 17 | 1% Colloidal silica | 1869 | −7.0 | −12.9 | 480 |
| | (Ludox SK) | | | | |
| 18 | 1% Aerosoil + 1% | 1636 | −5.1 | −8.5 | 480 |
| | Colloidal silica | | | | |
| 19 | 1% BaCl2 | 1873 | −14 | — | 344 |
| 20 | 1% Glass Bubbles (3M | 1827 | −25.04 | — | — |
| | K15) | | | | |
| 21 | 3% Glass Bubbles | 1729 | −26.28 | — | — |
| 22 | 1% Recycled Glass (Soda | 1821 | −31.64 | | |
| | Lime Silicate glass) | | | | |
| 23 | 1% BaCl2 + 1% Recycled | 1740 | −28.11 | — | 470 |
| | Glass | | | | |
| 24 | 1% BaCl2 + 3% Recycled | 1794 | −26.2 | — | 413 |
| | Glass | | | | |

For each of the above, the additives and weight percentages based on stucco are provided below:

| | | Vermi- | | Ex- | Col- | | | Ground | |
|---|---|---|---|---|---|---|---|---|---|
| | | culite | Sili- | panded | loidal | Silica | Glass | Recycled | Barium |
| | | 5 | cone | Perlite | silica | Fume | Bubbles | Glass | Chloride |
| No. | Sample Description | (wt %) | (wt %) | (wt %) | (wt %) | (wt %) | (wt %) | (wt %) | (wt %) |
| 1 | Control, 5/8″, no | — | — | — | — | — | — | — | — |
| | vermiculite, | | | | | | | | |
| 2 | Control, 5/8″, 100 lb/msf | 6 | 0.5 | — | — | — | — | — | — |
| | Vermiculite 5, | | | | | | | | |
| 3 | Control, 5/8″, 60 lb/msf | 4 | 0.5 | — | — | — | — | — | — |
| | Vermiculite 5 | | | | | | | | |
| 4 | Control, no Vermiculite, | — | — | — | — | — | — | — | — |
| | no silicone | | | | | | | | |
| 5 | Control, no Vermiculite, | — | — | — | — | — | — | — | — |
| | no silicone | | | | | | | | |
| 6 | No Vermiculite, | — | 0.5 | — | — | — | — | — | — |
| 7 | No vermiculite, CTRL | — | 0.5 | — | — | — | — | — | — |
| 8 | 1% Expanded perlite | — | 0.5 | 1 | — | — | — | — | — |
| | (HP-100) | | | | | | | | |
| 9 | 2% Expanded perlite | — | 0.5 | 2 | — | — | — | — | — |
| 10 | 1% Expanded perlite + 1% | — | 0.5 | 1 | — | 1 | — | — | — |
| | condensed Silica Fume | | | | | | | | |
| 11 | 1% Expanded perlite + 2% | — | 0.5 | 1 | — | 2 | — | — | — |
| | cond. Silica Fume | | | | | | | | |
| 12 | 2% Expanded perlite + 1% | — | 0.5 | 2 | — | 1 | — | — | — |
| | cond. Silica Fume | | | | | | | | |
| 13 | 2% Expanded Perlite | — | 0.5 | 2 | — | — | — | — | — |
| | (Aerosoil) | | | | | | | | |
| 14 | 1% Expanded Perlite | — | 0.5 | 1 | — | — | — | — | — |
| 15 | 1% Expanded Perlite + 1% | — | 0.5 | 1 | — | 1 | — | — | — |
| | Condensed Silica Fume | | | | | | | | |
| 16 | 2% Expanded Perlite + 1% | — | 0.5 | 2 | — | 1 | — | — | — |
| | Condensed Silica Fume | | | | | | | | |
| 17 | 1% Colloidal silica | — | 0.5 | — | 1 | — | — | — | — |
| | (Ludox SK) | | | | | | | | |
| 18 | 1% Expanded Perlite + 1% | — | 0.5 | 1 | 1 | — | — | — | — |
| | Colloidal silica | | | | | | | | |
| 19 | 1% BaCl2 | — | 0.5 | — | — | — | — | — | 1 |
| 20 | 1% Glass Bubbles (3M | — | 0.5 | — | — | — | 1 | — | — |
| | K15) | | | | | | | | |
| 21 | 3% Glass Bubbles | — | 0.5 | — | — | — | 3 | — | — |
| 22 | 1% Waste Glass (Soda | — | 0.5 | — | — | — | — | 1 | — |
| | Lime Silicate glass) | | | | | | | | |
| 23 | 1% BaCl2 + 1% Waste | — | 0.5 | — | — | — | — | 1 | 1 |
| | Glass | | | | | | | | |
| 24 | 1% BaCl2 + 3% Waste | — | 0.5 | — | — | — | — | 3 | 1 |
| | Glass | | | | | | | | |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1-35. (canceled)

36. A gypsum panel comprising a gypsum core and a first facing material and a second facing material sandwiching the gypsum core, wherein the gypsum core includes gypsum, a thermal insulation additive, and a shrinkage reduction additive
wherein the gypsum core includes 3 wt. % or less of vermiculite based on the weight of the gypsum in the gypsum core, and
wherein the gypsum panel passes ASTM E119-20.

37. The gypsum panel of claim 36, wherein the thermal insulation additive includes an endothermic additive, a thermally resistant additive, a flame-retardant additive, an intumescent additive, a charring additive, or a mixture thereof.

38. The gypsum panel of claim 36, wherein the thermal insulation additive includes a hydrate, a hydroxide, a borate, a phosphate, a carbonate, a nitrate, a clay, or a mixture thereof.

39. The gypsum panel of claim 36, wherein the thermal insulation additive includes expanded perlite.

40. The gypsum panel of claim 36, wherein the thermal insulation additive includes aluminum trihydrate.

41. The gypsum panel of claim 36, wherein the thermal insulation additive includes a glass.

42. The gypsum panel of claim 36, wherein the thermal insulation additive includes a soda lime glass.

43. The gypsum panel of claim 36, wherein the shrinkage reduction additive includes a silicone, a silicate, a silica, a ceramic oxide, a metal salt, or a mixture thereof.

44. The gypsum panel of claim 36, wherein the shrinkage reduction additive includes a silica.

45. The gypsum panel of claim 36, wherein the shrinkage reduction additive includes a colloidal silica.

46. The gypsum panel of claim 36, wherein the shrinkage reduction additive includes silica fume.

47. The gypsum panel of claim 36, wherein the shrinkage reduction additive includes a metal salt.

48. The gypsum panel of claim 36, wherein the shrinkage reduction additive includes barium chloride.

49. The gypsum panel of claim 36, wherein the shrinkage reduction additive includes a clay.

50. The gypsum panel of claim 36, wherein the thermal insulation additive is present in an amount of 0.001 wt. % to 5 wt. % based on the weight of the gypsum panel.

51. The gypsum panel of claim 36, wherein the shrinkage reduction additive is present in an amount of 0.001 wt. % to 5 wt. % based on the weight of the gypsum panel.

52. The gypsum panel of claim 36, wherein the vermiculite is present in an amount of 0.1 wt. % or less based on the weight of the gypsum in the gypsum core.

53. The gypsum panel of claim 36, wherein the gypsum panel exhibits a shrinkage in the thickness direction of 15% or less.

54. The gypsum panel of claim 36, wherein the gypsum panel exhibits a shrinkage in the width-length direction of 15% or less.

55. The gypsum panel of claim 36, wherein the gypsum panel has a nail pull resistance of from 77 lb_{f} to 110 lb_{f}.

56. The gypsum panel of claim 36, wherein the gypsum panel has a core compressive strength of from 200 psi to 1500 psi.

57. A method of making the gypsum panel of claim 36, the method comprising:
providing the first facing material,
providing a gypsum slurry comprising gypsum, water, the thermal insulation additive, and the shrinkage reduction additive onto the first facing material,
providing the second facing material on the gypsum slurry.
